(19) United States
(12) Patent Application Publication
(10) Pub. No.: US 2019/0325385 A1
(43) Pub. Date: Oct. 24, 2019

(54) SYSTEMS AND METHODS OF TRACKING QUANTITIES OF RETAIL PRODUCTS

(71) Applicant: Walmart Apollo, LLC, Bentonville, AR (US)

(72) Inventors: Jeremy R. Tingler, Bentonville, AR (US); Nicholaus A. Jones, Fayetteville, AR (US); Alvin S. Taulbee, Springdale, AR (US)

(21) Appl. No.: 16/386,569

(22) Filed: Apr. 17, 2019

Related U.S. Application Data
(60) Provisional application No. 62/660,634, filed on Apr. 20, 2018.

(51) Int. Cl. G06Q 10/08; G06K 7/10; G06K 19/07

(52) U.S. Cl. CPC G06Q 10/0875; G06K 19/0723; G06K 7/10297

(57) ABSTRACT

Retail product inventory tracking systems are provided. The systems, in some embodiments, comprise: multiple sets of RFID tags positioned relative to product support systems; multiple RFID tag readers; and an inventory estimation control circuit configured to: receive detected RFID tag information and an RFID tag identifier of each read RFID tag of a first set of non-product RFID tags; obtain and use a first set of rules to evaluate, for each read RFID tag, the RFID tag information relative to the RFID tag information of two or more of the other read RFID tags of the first set of RFID tags; obtain and use a second set of rules to determine, based on the evaluation of the RFID tag information, a quantity of items of a first product that continue to be supported by a first product support system.

### CROSS-REFERENCE TO RELATED APPLICATION

This application claims the benefit of U.S. Provisional Application No. 62/660,634, filed Apr. 20, 2018, which is incorporated herein by reference in its entirety.

### TECHNICAL FIELD

This invention relates generally to inventory management.

### BACKGROUND

Retail store inventory tracking can be important to many retail stores. Many stores and businesses use radio frequency identification (RFID) technology for detecting commercial items having RFID tags. RFID tag readers are used to read the RFID tags. However, there are some drawbacks to RFID tags.

### BRIEF DESCRIPTION OF THE DRAWINGS

Disclosed herein are embodiments of systems, apparatuses and methods to improve inventory management. This description includes drawings, wherein:

FIG. 1 illustrates a simplified block diagram of an exemplary retail product inventory tracking system, in accordance with some embodiments;

FIG. 2 illustrates a simplified plane view of a product support system with multiple shelves supporting items of one or more products, in accordance with some embodiments;

FIG. 3 illustrates a simplified overhead view of a product support system with multiple items supported by the product support system, in accordance with some embodiments;

FIG. 4 illustrates a simplified graphical representation of exemplary RFID tag Received Signal Strength Indication (RSSI) detected by a particular RFID tag reader over time from a non-product RFID tag, in accordance with some embodiments;

FIG. 5 illustrates a simplified flow diagram of a process of tracking retail product inventory on a sales floor of a retail shopping facility, in accordance with some embodiments; and

FIG. 6 illustrates an exemplary system for use in implementing methods, techniques, devices, apparatuses, systems, servers, sources and providing inventory tracking on a sales floor of a retail store, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods enable the tracking of product inventories and/or quantities on the sales floor of a retail shopping facility. The shopping facility includes numerous product support systems (e.g., shelf systems, bins, racks, and other such systems that are configured to support items on the sales floor for retrieval by customers intending to purchase the items from the shopping facility. Multiple sets of multiple radio frequency identification (RFID) tags strategically positioned relative to each of multiple different product support systems distributed throughout the shopping facility. Further, multiple RFID tag readers are distributed about the shopping facility at positioned to detect numerous RFID tags in the shopping facility. In some instances, some of the RFID tag readers may be restricted to detecting only those RFID tags strategically positioned relative to the different product support systems, while other RFID tag readers may be configured to detect RFID tags associated with items for sale. In other implementations, one or more of the RFID tag readers may be configured to detect RFID tags from those strategically positioned relative to product support systems as well as tags associated with items supported on the product support systems.

The sales floor inventory tracking system further includes one or more inventory estimation control circuits that communicatively coupled with the multiple RFID tag readers via wired and/or wireless communication. By evaluating RFID tag signals and/or corresponding RFID tag information relative to other RFID tag signals and/or information, the inventory estimation control circuit can in part estimate quantities of items that continue to be supported by a product support system. In some embodiments, the inventory estimation control circuit receives from one or more of the RFID tag readers detected RFID tag information corresponding to each RFID tag of a set of RFID tags cooperated with a product support system. The inventory tracking system accesses one or more sets of rules to evaluate the RFID tag information and/or determine inventory quantities based on the received RFID tag signals and/or information determined from those signals. In some embodiments, a set of at least one rule is used to evaluate RFID tag signals and/or corresponding information relative to a particular product support system. For each read RFID tag of the set of tags and from which an RFID tag signal is detected, the inventory estimation control circuit can evaluate the RFID tag information of each tag of the set relative to the RFID tag information of one or more of the other read RFID tags of the set of RFID tags positioned relative to the product support system. One or more other sets of rules can be used by the inventory estimation control circuit to determine, based on the evaluation of the RFID tag information of the read RFID tags, a quantity of items of a product that continue to be supported by the product support system.

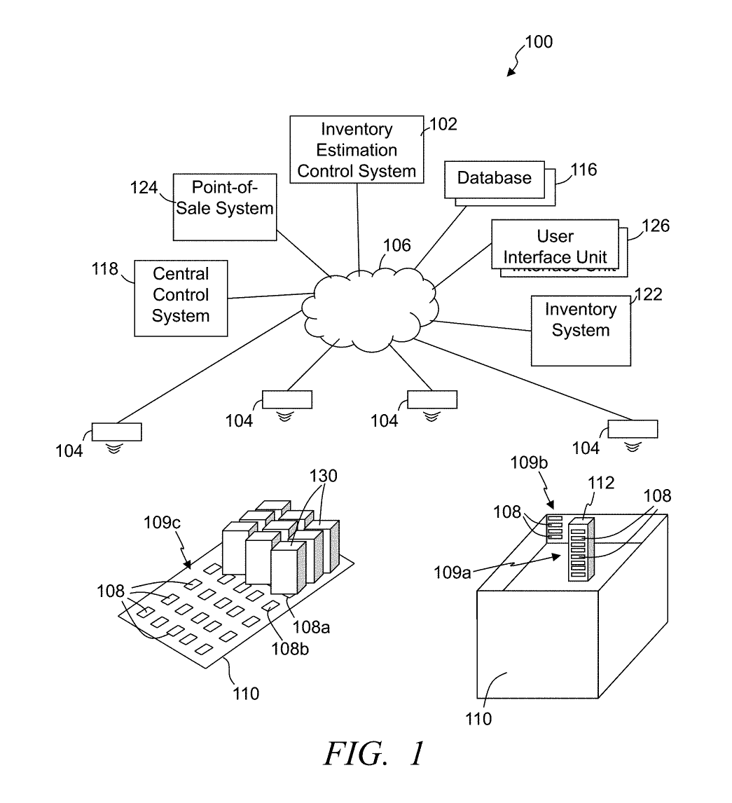

FIG. 1 illustrates a simplified block diagram of an exemplary retail product inventory tracking system 100, in accordance with some embodiments. The system includes one or more inventory estimation control circuits (IECC) 102, multiple RFID tag readers 104 that communicate with the inventory estimation control circuit 102 through one or more communication and/or computer networks 106, and multiple sets 109 of fixed location, non-product RFID tags 104 with at least some of the sets of RFID tags being strategically positioned relative to each of multiple different product support systems 110 (e.g., shelves, bins, racks, modulars, and the like). Depending on the type of product support system, the sets of non-product RFID tags may be positioned along a side of the product support system (e.g., arranged vertically on interior side walls of bins), arranged on a tower 112 or other structure (e.g., a tower protruding from a bin with RFID tags arranged along one or more portions of the tower), distributed across a surface (e.g., on a shelf), and/or other such strategic arrangements relative to a product support structure.

As one example, a product support bin may be configured to support products that are placed or arranged within the bin (e.g., apples within a bin). One or more first sets 109a of non-product RFID tags 108 may be vertically arranged along one or more towers 112 extending from an interior bottom of the bin, and a second set 109b of non-product RFID tags 108 may be vertically arranged along an interior side of the bin. As the number of the products (e.g., apples, oranges, lemons, or other such produce) added to the bin increases the number of non-product RFID tags 108 of both the first and second sets of RFID tags are covered by the produce. The produce covering the one or more non-product RFID tags often interfere with the RFID signals between the RFID tag readers 104 and the RFID tags 108 of the product support systems 110. However, in many instances, some RFID tags 108 may be detected by an RFID tag reader even though it may be partially or fully covered by one or more of the produce. Typically, however, the signals from such partially or fully covered RFID tags 108 can be distinguished from non-covered RFID tags based on differences in RFID tag information detected by the one or more RFID tag readers 104. As further described below, such RFID tag information may include signal strength, a rate of reading of the particular RFID tag, and/or other such information.

The inventory estimation control circuit 102 is configured to evaluate the RFID tag information and/or signals of each detected or read non-product RFID tag 108 relative to RFID tag information corresponding to multiple proximate and/or neighboring non-product RFID tags 108 of one or more sets of RFID tags. In some instances, RFID tag information and an RFID tag identifier are obtained from an RFID signal emitted by a first non-product RFID tag, which is part of a first set of non-product RFID tags (e.g., first set 109a). This RFID tag information of the first RFID tag is evaluated relative to at least one and typically at least two other RFID tags of the first set of RFID tags of which the first RFID tag is a part and/or RFID tags that are within a threshold distance, height and/or orientation of the RFID tag being evaluated. For example, a first plurality of RFID tags organized along a first side of a tower 112 of a bin may be considered a first set 109a, while a second plurality of RFID tags organized along an inside of a first side wall of the same bin may be a second set 109b. In some instances, a third plurality of RFID tags organized along a second side of the tower may be considered part of the first set, while in other instances, the third plurality of RFID tags may be considered a third set. Similarly, multiple non-product RFID tags 108 positioned on a shelf surface or under a shelf surface may be organized into one or more sets 109c. The organization of the RFID tags into sets may be dependent on the type of RFID tags employed, differences between RFID tags, distances between RFID tags, types of products being placed on the shelf, other interference aspects, differences in detection of different RFID signals at different RFID tag readers, and/or other such considerations.

Some embodiments define sets 109 of RFID tags that overlap, such that one or more RFID tags may be defined as being part of two or more different sets of RFID tags. For example, multiple RFID tags may be considered part of a first set relative to a first RFID tag reader, and considered part of a second set relative to a different second RFID tag reader. Additionally or alternatively, multiple RFID tags may be part of a first set relative to a first RFID tag reader, while being defined as also part of a second set to the same first RFID tag reader based on positioning of the multiple RFID tags relative to the other RFID tags of the two different sets (e.g., a line of RFID tags that extends into both sets). Items 130 of one or more products that are placed on the shelf or other support system typically interfere with RFID tag signals and RFID tag readers from reading the signals (e.g., items that reflect or absorb signal energy), which will prevent or limit those tags from being read. The inventory estimation control circuit typically is not attempting to identify a particular RFID tag or a particular tag identifier of an RFID tag (e.g., a tag that corresponds to a single item or single location), but instead evaluates a collection of numerous RFID tags, where typically some of those tags are not being read or that are being limited in reads. Additionally, the RFID tags being evaluated are typically non-product RFID tags that are associated with and/or secured with a product support system 110. Further, the evaluation in some embodiments compares RFID parameters of different RFID tags in order to identify RFID tags of a set of RFID tags that have one or more parameter threshold similarities and/or one or more parameter threshold differences. In some embodiments, the RFID tags 108 of a set and/or associated with a product support system are similar in design and/or manufacturer, and in some instances are obtained from a single assembly batch. For example, the RFID tags may be selected from a single manufacturer and in some instances manufactured from the same silicon and/or even same wafer. This provides enhanced likelihood of consistency of RFID signals between the different RFID tags. Additionally or alternatively, RFID tags may be tested and RFID tags selected having signals and/or one or more RFID parameters that are within thresholds of each other. Still further, some embodiments may test RFID tags and take differences based on those tests into consideration (e.g., applying one or more adjustment factors based on test results) in evaluating RFID tag information between different RFID tags.

Still referring to FIG. 1, in some embodiments, the product inventory tracking system 100 further includes one or more databases 116 that maintain information, parameters, settings, historic information, and the like. For example, the one or more databases 116 may include one or more RFID tag databases that maintains information about the defined sets of RFID tags, changes to sets of RFID tags based on continued evaluation of relationships and/or differences between reads of different RFID tags, RFID tag associations between RFID tag readers, restrictions, historic data RFID parameters (e.g., RSSI, read rates, etc.), current RFID parameters, and/or other such information. Some embodiments maintain one or more inventory databases that tracks information about current, historic, expected and/or forecasted product quantities, pending product orders, received shipments, expected shipments, product demand, product placement within the shopping facility (e.g., one or more locations on the sales floor, one or more locations in a back storage area, one or more remote or external storage locations, etc.), sales rates, and/or other such information. One or more rules engines, databases and the like may be maintained and/or accessed to use rules in evaluating RFID tag information, determine estimated quantities of inventory, determine actions to be taken, and the like.

Further, in some embodiments, the product inventory tracking system 100 includes or is in communication with a central control system 118 that is configured to communicate and/or control other systems of the shopping facility. Similarly, the product inventory tracking system 100 may include or communicates with an inventory system 122 that tracks inventory at least at the shopping facility, and may track expected inventory, initiate orders for additional shipments, notify one or more workers regarding potential inventory problems, initiate restocking of the back storage area and/or the sales floor of the shopping facility, initiate one or more tasks at the shopping facility (e.g., picking, repricing, product movement, etc.), and the like. Additionally, the product inventory tracking system 100 may include or communicates with multiple point-of-sale (POS) systems 124 at the shopping facility. The POS systems enable the sale of the products to customers, and may include shopping facility worker operated POS systems, customer self-service POS systems, sales through customer user interface units 126 while at the shopping facility (e.g., smartphones, tablets, and other such portable devices), and/or other such POS systems. In some implementations, the product inventory tracking system 100 includes and/or is in communication with worker user interface units 126 (e.g., smartphones, tablets, product scanning devices, desktop computer, etc.) that enable the system and/or a central control system 118 to communicate instructions to one or more workers, receive information from workers, and the like.

In some embodiments, multiple sets of multiple RFID tags 108 are strategically positioned relative to each of multiple different product support systems 110 that are distributed throughout the shopping facility. Further, multiple RFID tag readers 104 are positioned typically at fixed locations about the retail shopping facility. In some embodiments, multiple RFID tag readers are mounting in the ceiling, some may be fixed to product support systems, some may be positioned on the floor, and/or other such locations through some or all of the shopping facility.

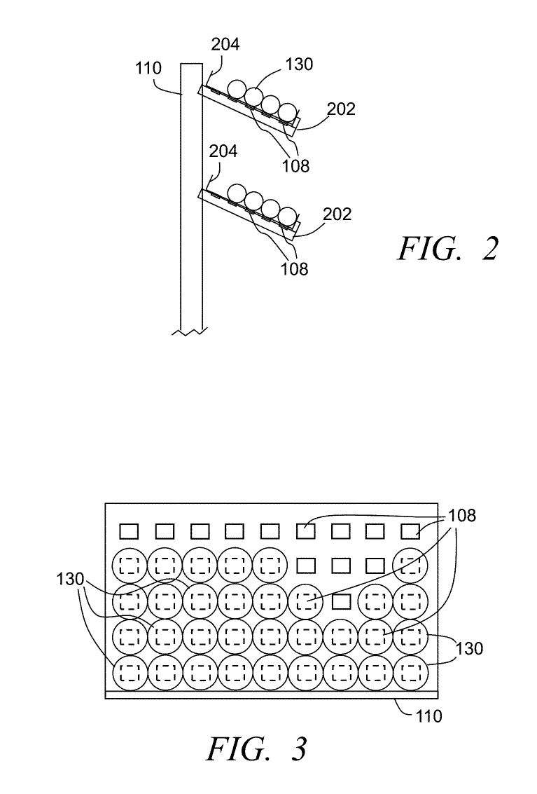

FIG. 2 illustrates a simplified plane view of a product support system 110 with multiple shelves 202 supporting items 130 of one or more products, in accordance with some embodiments. FIG. 3 illustrates a simplified overhead view of a product support system 110 (e.g., a shelf 202 of FIG. 2) with multiple items 130 supported by the product support system, in accordance with some embodiments. Multiple non-product RFID tags 108 are positioned relative to the shelf (e.g., on top of the shelf, under the shelf, embedded within part of the shelf, under a protective layer on the shelf, etc.). In some instances, the items 130 may be positioned within a portable bin 204 that is placed on the shelf 202. The RFID tags 108 may be part of the bin or may be cooperated with the shelf. It is noted that the items 130 may include item RFID tags that may additionally transmit RFID signals that may be detected by the same of different RFID tag readers as those readers that are reading the non-product RFID tags 108 that are cooperated with the product support systems 110.

Referring to FIGS. 1-3, the inventory estimation control circuit 102 is communicatively coupled with the multiple RFID tag readers 104 and receives RFID tag information and corresponding RFID tag identifiers corresponding to each detected RFID tag read by the multiple RFID tag readers. The inventory estimation control circuit accesses one or more databases, rules engines, or the like, and obtains one or more sets of rules to at least evaluate the received RFID tag information. The RFID tag information can include information such as but not limited to RFID tag reader identifier information of the RFID tag reader that detected an RFID tag signal, other identifier information (e.g., product support system with which the tag is associated), tag read rates, an interference rate (e.g., a factor indicating a rate or how often there is interference around an RFID tag), received signal strength (e.g., received signal strength indicator (RSSI) or other indicator of how much energy is being outputted back to the RFID tag reader), angle of detected arrival, antenna upon which a signal is detected, other such information, and often a combination of two or more of such parameter information.

The inventory estimation control circuit 102 can further access RFID tag placement and/or mapping information identifying locations of RFID tags and/or product support systems positioning within a retail store based on the read RFID tags, product support system association information that identifies product support systems with which each RFID tag is affixed with or otherwise positioned relative to, shopping facility mapping information, product placement mapping information identifying placement within the shopping facility of different products, and/or other such information. In some embodiments, for example, the inventory estimation control circuit receives detected RFID tag information and RFID identifier information of each read RFID tag of a first set of RFID tags cooperated with a first product support system 110. Some or all of the RFID tag information may be received from one or more RFID tag readers, accessed from one or more non-tangible computer memory, databases, or the like. Further, the inventory estimation control circuit may identify and distinguish, from multiple different RFID tag information associated with multiple different sets of RFID tags, the RFID tag information associated with RFID tags of a first set of tags that are cooperated with a first product support system.

In some embodiments, the inventory estimation control circuit obtains and uses one or more sets of at least one rule to evaluate, for each read RFID tag of a particular set 109 of RFID tags being considered relative to a product support system 110, the RFID tag information of that RFID tag relative to the RFID tag information of at least one and typically two or more of the other read RFID tags of the same set 109 of RFID tags. The first set of rules can evaluate tag read rates between multiple different detected RFID tags at a single RFID tag reader and/or multiple RFID tag readers, evaluate RSSI between multiple detected RFID tag signals from multiple RFID tags at a single and/or multiple RFID tag readers, evaluate angles of detected arrival of RFID signals from multiple RFID tags as detected by one or multiple RFID tag readers, compare through which antenna of one or more multi-antenna RFID tag readers that RFID tag signals are detected, and/or other such evaluations of RFID tag information. Accordingly, a given read parameter (e.g., RSSI) from a first RFID tag of a first set of tags can be evaluated relative to the same read parameter from other RFID tags of the first set of tags.

In some embodiments, the rules further evaluate the RFID tag information relative to one or more thresholds. For example, the inventory estimation control circuit may identify when a read rate from a first RFID tag of a set of RFID tags is a threshold different than the read rates of one or more other RFID tags of the same set of RFID tags. As another example, the inventory estimation control circuit may determine whether RSSI corresponding to the first tag of the set is within a threshold difference with the RSSI of one or more other RFID tags of the same set, and typically being received within a threshold period of time. The evaluations can further adjust thresholds over time based on one or more factors, such as average differences in RFID tag information between adjacent RFID tags of a set of RFID tags, adjustments based on one or more predefined time periods and/or in response to receiving an indication from a worker of a state of the product support system (e.g., following a filling of a shelf or bin, receiving a confirmation that a shelf or bin is empty, etc.). Accordingly, the results obtained by the system could not be obtained by a person, nor could the results be obtained within a reasonable time to accurately track inventory of the product support systems of a shopping facility.

Further, the rules may dictate which RFID tags of a set to consider relative to an RFID tag of the system being considered. As an example, a first RFID tag may be known to be positioned at a first height within a product support bin, and one or more rules may restrict a comparison of the read rate of the first RFID tag to read rates of RFID tags higher than the first RFID tag. Typically in a bin type product support system, as products are removed by customers for purchase, the height of the products gradually lowers over time further exposing additional RFID tags (e.g., RFID tags on a tower 112). Accordingly, as products are removed the RFID tags higher on the tower typically are exposed earlier than lower RFID tags of the set and products do not interfere with their signals. As such, one or more rules may direct the inventory estimation control circuit to evaluate RFID tag information associated with a lower RFID tag relative to RFID tag information associated with RFID tag information associated with higher RFID tags. Other rules may additionally or alternatively direct the evaluation of RFID tag information associated with a first RFID tag relative to RFID tag information of one or more lower RFID tags. One or more rules may dictate a determination of whether one or more RFID parameters (e.g., signal rate, RSSI, angle of arrival, etc.) have a threshold difference than corresponding RFID parameters associated with one or more lower RFID tags. Such considerations between related RFID tags are not considered by workers at the shopping in determining and/or estimating product quantities, or within a reasonable time to provide meaningful information that can be acted upon in a timely manner. Similarly, the rules can vary the thresholds over time based on continued monitoring of RFID tag information and/or parameters, which would not be considered by workers at the shopping facility or within a reasonable time to provide meaningful information that can be acted upon in a timely manner. Such adjustments to thresholds may, for example, be defined based on consistent signals and/or parameters being detected over time. Further considerations may be taken into account, such as a human entered count quantity, which can be used to associate a current RFID tag information with a known condition. Accordingly, the results obtained based on the application of rules are different than would be determined by a worker.

Further, based on the evaluation and comparison of RFID tag information between different RFID tags in accordance with one or more rules, the system can determine which RFID tags are having their RFID signals fully or partially interfered with by one or more items supported by the product support system. Again, the rules may apply one or more thresholds to identify when RFID tag information and/or parameters are a threshold similar or different from RFID tag information and/or parameters of one or more other RFID tags of the set (e.g., difference of at more than a ¼ of an RSSI, difference of about half a read rate, difference of about 90 degree arrival angle, etc.). As an example, an array of RFID tags with X tags per column (e.g., along a depth of a shelf) and Y tags per row (e.g., along at least a part of a length of the shelf) may be cooperated with at least a portion of a shelf of a product support system. As items 130 are removed from a front of the shelf, the RFID tags under those products are more fully exposed. In other instances, the shelf may be at an angle such that as items are removed items behind slide down toward outer edge exposing RFID tags deeper along the columns. Adjacent RFID tags (e.g., 108a, see FIG. 1) are often still covered by items on the shelf while other RFID tags (e.g., 108b, see FIG. 1) are no longer covered. The differences in RFID tag information allows the inventory estimation control circuit uses the similarities and difference in RFID tag information between RFID tags of a set to identify those RFID tags of the set of tags that are no longer or only partially covered by one or more items. Using knowledge of location of these RFID tags (e.g., based on a mapping), and information about the item 130 placed on the shelf (e.g., dimensions of the item, RFID signal interference characteristics, and the like), the system can estimate the quantity of items continuing to be supported by the shelf (e.g., known area of the shelf, known number of non-product RFID tags 108, accurately read non-product RFID tags 108 used to calculate free or unoccupied area on the shelf, determine occupied space based on dimensions of shelf and unoccupied area, and use dimensions of the items on the shelf allows to determine the number of items on the shelf).

In some embodiments, the inventory estimation control circuit 102 uses one or more additional quantity estimation sets of at least one rule to determine a quantity of items based on RFID tag information and/or the RFID tags determined to be exposed and/or at least partially not interfered with by products supported by the product support system. Some embodiments further apply rules in determining quantities of items based additionally or alternatively on RFID tags that are partially and/or fully blocked or interfered with by items supported on the corresponding product support system. Using the quantity estimation set of rules, the inventory estimation control circuit can determine, based on the evaluation of the RFID tag information of the read RFID tags, a quantity of items of a product that continue to be supported by the product support system.

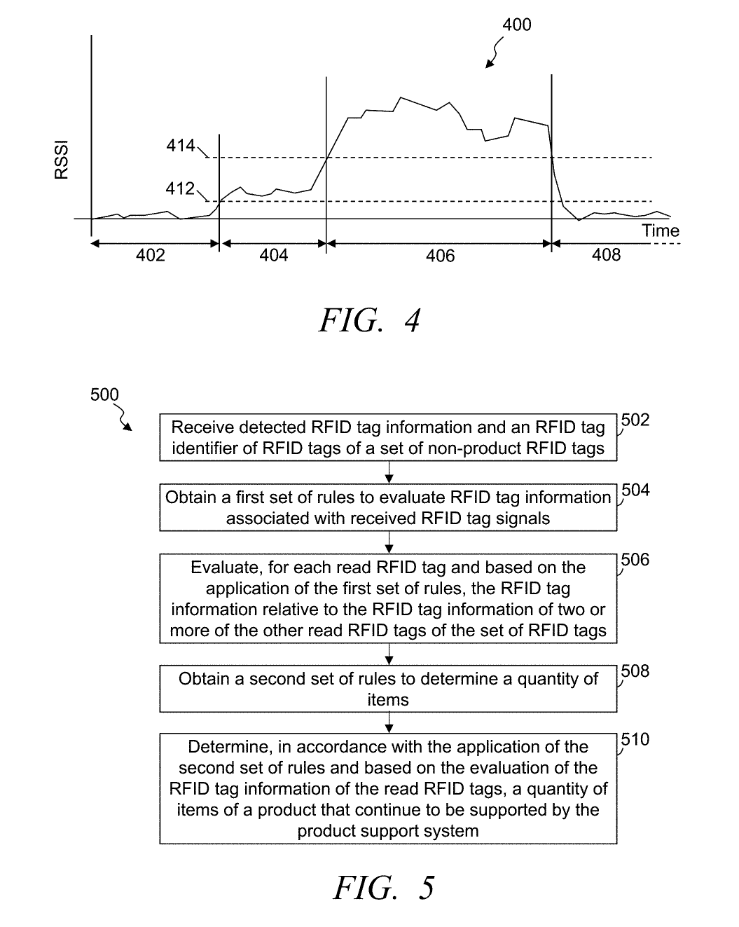

FIG. 4 illustrates a simplified graphical representation of exemplary RFID tag Received Signal Strength Indication (RSSI) 400 detected by a particular RFID tag reader 104 over time from a non-product RFID tag 108, in accordance with some embodiments. Typically, the RSSI is a measurement of the strength of a radio signal being received. The graphical representation of the RSSI for the RFID tag initially illustrates that the RSSI is very low or not detected for a period of time 402 corresponding to a duration while one or more items 130 are blocking the particular RFID tag. During a second period of time 404 the RSSI may increase while one or more items are partially blocking the RFID tag, while during a third period of time 406 the RSSI value fluctuates about a maximum corresponding to when items are not interfering with the signal from the RFID tag (e.g., no item 130 is between the RFID tag and the RFID tag reader). Typically, the read will not be completely consistent as multi-pathing, temporary interference (e.g., customer passing by) will skew the results. A fourth duration 408 illustrates the RSSI returning to a low or not detected states, for example, after the product support system has been restocked such that one or more items 130 interfere with the RFID signal. In some instances, one or more thresholds 412, 414 may indicate sufficient levels of RSSI to correspond to the different states (e.g., an RFID tag is fully covered by one or more items while RSSI is below a first threshold 412, partially covered when the RSSI is between the first threshold 412 and a second threshold 414, and uncovered when the RSSI is above the second threshold 414). Similar read results are detected with respect to other RFID properties of the RFID tag information (e.g., tag read rates, interference rate, etc.). For example, read rates of RFID tags would be low or zero while those tags are covered by one or more items, the read rates may increase for an RFID tag when it is partially covered, and would be fluctuate near a maximum or above a threshold while the RFID tag was not covered.

As described above, the RFID properties of the RFID tag information (e.g., RSSI, read rate, etc.) of the RFID tags of a set can be compared with the corresponding RFID properties of RFID tag information of the other RFID tags within that set. The comparison can be based on reads at a given time, determined over a limited period of time, compared based on historic reads (e.g., detecting changes over time), and the like. Again, the RFID properties of the RFID tag information are expected to fluctuate while in any one given state (e.g., based on reflections, multi-paths, temporary interference, etc.). Accordingly, in some embodiments, detected information for any one of the RFID properties of the RFID tag information may be averaged over short durations (e.g., less than 10 seconds and often less than 1 second), or other statistical evaluation of RFID properties can be performed (e.g., median, standard deviation, etc.). The inventory estimation control circuit 102 can apply a set of one or more rules to evaluate the RFID tag information. The one or more rules, in some applications compares the statistical processing of one or more of the RFID tag information corresponding to one RFID tag with similar statistical processing of corresponding RFID tag information for one or more other RFID tags of the set of RFID tags. This comparison between multiple different RFID tags within the set allows the inventory estimation control circuit 102 to accurately detect the different states and/or transitions between thresholds of the different RFID tag information, at least because the set of RFID tags are typically exposed to similar external conditions at a given time (e.g., customer passing by, a shelf or bin being restocked, a shopping cart left at a location, etc.).

Some embodiments take advantage of the arrangement of the sets or arrays of RFID tags in estimating quantities. For example, some implementations position and arrange at least some of the RFID tags of a set of RFID tags at different heights relative to a depth of a product support system (e.g., product bin) that is configured to receive multiple items of one or more products. As items are added to the bin at least some of the multiple items end up positioned under others of the multiple items within the bin. For example, a bin supporting apples would have apples at the bottom of the bin and apples piled on top to at least partially fill the bin. As the depth of the items increases, more of the RFID tags arranged at different heights are covered, while one or more may continue to be partially or fully exposed or otherwise uninterrupted by the items. Similarly, RFID tags may be arranged on a shelf with some of the RFID tags being deeper or further from the front of the shelf than other RFID tags. As items are placed on the shelf some or all of the RFID tags may be covered and/or some of the items may interfere with the RFID signal being transmitted from one or more RFID tags. Similarly, as items are removed from the shelf (e.g., by customers) the signals from the number of RFID tags that are no longer interfered with and/or are only partially interfered with increases. As an example, in a milk cooler a row of milk might have a shelf capacity of eight 1-gallon items of milk. In some applications, a “milk” set of eight or more RFID tags can be arranged strategically relative to the shelf so that each of the milk set of RFID tags were block when the shelf is full with the milk items sitting on it. As a 1-gallon item of milk is removed the remainder of the milk items may slide down exposing one or more rear most RFID tags of the milk set of RFID tags. Since the rear most one or more RFID tags are now exposed, the proximate one or more RFID tag readers 104 can now read the signals from those one or more rear most RFID tags of the milk set. By comparing one or more RFID parameters of the RFID tag information between the different RFID tags, the inventory estimation control circuit 102 can confirm the unblocked state of the one or more rear most RFID tags and use the information of the number of rear most RFID tags to determine an estimated remaining number of milk items remain on the milk shelf, based on the known dimensions of the milk items, and the capacity and/or dimensions of the milk shelf. As another example, an array or grid of RFID tags may be positioned within a fruit bin (or other such bin). The array of RFID tags may be laid in the bottom of the bin, positioned along a tower, positioned along a side of the bin, and/or other such arrangement. As items are removed more and more tags are exposed and read by the corresponding RFID tag readers 104. In this case though the items are stacked on top of each other. Based on the number of RFID tags that are fully being read (based on the comparison of RFID parameters between RFID tags of the set), a percentage of remaining stock can be determined (e.g., if the array of RFID tags includes 100 RFID tags and 25 of those RFID tags are fully read, an approximate quantity of 75% in-stock may be determined).

Using the RFID tag information from those RFID tags that are detected can then be associated with predefined quantities that are known to be supported by the product support system. In some embodiments, the one or more sets of RFID tags of a particular product support are tested to establish baselines by placing known quantities of products on or within the product support system and associating those known quantities with the correspond detected RFID tag information from the various RFID tags of the set. Progressive baselines can be determined by continuing to add to the product support system with known quantities of an item until the product support is at a desired capacity and/or beyond a desired capacity to be able to identify quantities of an item in excess of a desired capacity (e.g., worker overstocks a shelf or bin). Additionally or alternatively, the inventory estimation control circuit can track over time the RFID tag information of RFID tags of one or more sets in relation to inventory information, such as but not limited to confirmations of a worker restocking at known quantity of items, item counts performed by workers, point-of-sale data confirming items being purchased and thus removed from the product support system, confirmation that there are zero remaining items on a product support system, evaluating historic RFID tag information following a confirmation of a known quantity of an item (e.g., report that there are zero items remaining, a count is received from a worker, etc.), other such information, or a combination of two or more of such information. In many instances, the correlations between quantities of an item and the detected RFID tag information is continuously monitored and updated based on continued feedback (e.g., notice of restocking, notice of sale, notice of a zero quantity, notice of a count, etc.). Similarly, some embodiments compare RFID tag information of RFID tags of different sets of RFID tags associating with a single product support system. The different sets may provide a confirmation of estimated quantity. When a threshold difference is identified the estimated quantity of an item supported by the product support system may be adjusted based on the difference (e.g., assuming a slope of items between the different sets and estimate a quantity based on the estimated slope of items).

In some embodiments, the inventory estimation control circuit uses one or more sets of estimation rules in determining the quantity of items to identify, based on the evaluation of the RFID tag information of those read RFID tags, a sub-set of one or more of the RFID tags of the set of RFID tags that have their RFID signal interfered with by one or more of the items of a product. Additionally or alternatively, some embodiments identify another sub-set of one or more of the RFID tags of the first set of RFID tags from which RFID signals are not received. Based on the known locations of each of the sub-set of RFID tags relative to the product support system, a quantity of the items of the product that continue to be supported by the product support system can be determined. For example, a quantity of 60 apples may be associated with a first sub-set of RFID tags (e.g., lower tags) being interfered with by at least a threshold, and a second sub-set of RFID tags not being interfered with by at least the threshold level. As another example, a quantity of 10 cans of soup may be associated with a first sub-set of RFID tags being interfered with by at least a threshold, and a second sub-set of RFID tags not being interfered with by at least the threshold. It is noted that with some product support systems and/or some arrangements of RFID tags associated with a product support system RFID tags that are interfered with may not be adjacent. Further, some embodiments identify threshold changes of RFID tag information between adjacent RFID tags as an indicator of a removal of placement of an items, and the inventory estimation control circuit can continue to track this threshold change to confirm that subsequent changes are consistent with a corresponding removal of subsequent items or further placement of subsequent items. This consistent change over time can be used to confirm estimations (e.g., based on detecting of a restocking, consistent with customers shopping, etc.). Some embodiments, in identifying the sub-set of one or more of the RFID tags, identify when a first RFID property of the RFID tag information associated with a first RFID tag is not within a first property threshold of a first RFID property of the RFID tag information associated with a second RFID tag.

The inventory estimation control circuit, in some embodiments, can use one or more sets of rules to evaluate the RFID tag information and determine whether an RFID property of RFID tag information corresponding to a first RFID tag (e.g., 108a) of a set is within a threshold of the same RFID property of RFID tag information of one or more other RFID tags (e.g., 108b) of the set. Based on this evaluation, the inventory estimation control circuit can identify when the RFID property corresponding to the first RFID tag is not within the threshold of the RFID property of the one or more other RFID tags of the set. Based on the threshold difference, it can be determined for at least some RFID properties that at least one item 130 of a product is positioned on the corresponding product support system 110 and interfering with an RFID signal from the first RFID tag 108a. One or more rules of one or more sets of estimation rules can further be obtained and used by the inventory estimation control circuit to determine the quantity of items based on the determination that the at least one item of the product is positioned to interfere with the RFID signal from the first RFID tag.

Again, some embodiments use the evaluation set of rules to evaluate the RFID tag information relative to RFID tag information of two or more of the other read RFID tags and determine whether a second RFID property of RFID tag information of the first RFID tag 108a is within a second threshold of a second RFID property of RFID tag information of a second RFID tag 108b. Some embodiments may identify, only when at least two or more RFID properties (e.g., the first and second RFID properties) associated with the first RFID tag are not within corresponding thresholds (e.g., the first and second thresholds, respectively), of corresponding RFID parameters (e.g., the first and second RFID properties) associated with one or more other RFID tags (e.g., the second RFID tag 108b), that at least one item 130 of the first product is positioned on the first product support system 110 to interfere with the RFID signal from the first RFID tag 108a.

For example, the RFID tag information may comprises an RSSI value. The inventory estimation control circuit in using the first set of rules to evaluate the RFID tag information relative to RFID tag information of two or more of the other read RFID tags can determine whether an RSSI of a first RFID tag is within a threshold of an RSSI of a second RFID tag. Based on the threshold relationship the inventory estimation control circuit can identify that at least one item 130 of the first product is positioned on the first product support system to interfere with a RFID signal from the first RFID tag. The inventory estimation control circuit can use one or more estimation sets of rules to determine the quantity of items based on the determination that the at least one item of the first product is positioned to interfere with the RFID signal from the first RFID tag. In some embodiments, the product inventory tracking system 100 evaluates how different RFID tags are read relative to other RFID tags and how those other tags are read over time in determining whether an item 130 interferes with an RFID tag. Further, the system is considering multiple RFID tags collectively as a group and relative similarities and/or differences between RFID tag information associated with the group of RFID tags in estimating quantities of items instead of identifying individual RFID tags.

FIG. 5 illustrates a simplified flow diagram of a process 500 of tracking retail product inventory on a sales floor of a retail shopping facility, in accordance with some embodiments. In step 502, detected RFID tag information and an RFID tag identifier of each read RFID tag 108 of a set of RFID tags are received. Typically, the RFID tag information is received from one or more RFID tag readers 104 of multiple RFID tag readers distributed about a retail shopping facility and/or determined based on information from the RFID tag readers. For example, the RFID tag reader may provide RFID tag information that includes an RFID tag identifier of each RFID tag read, signal strength information, rate at which RFID tags are each read, indication of an antenna or antennas on which an RFID tag signal is detected, and the like. Further, in some embodiments, the inventory estimation control circuit obtains RFID tag information based on one or more of the information received from the RFID tag reader (e.g., historic receive rates, historic RSSI, location information of an identified RFID tags, an identification of one or more other RFID tags with which the RFID tag is associated (e.g., identification of one or more sets of RFID tags in which the RFID tag is associated), an association with a product support system, an association with one or more products, and/or other such information. Additionally, the RFID tag is cooperated with a first product support system 110 of the multiple product support systems at the shopping facility.

In step 504, an evaluation set of rules are obtained to evaluate RFID tag information associated with received RFID tag signals. The rules may be provided by one or more rules engines, one or more rules database 116 and/or other source. In step 506, the evaluation set of rules are used and applied by the inventory estimation control circuit 102 to evaluate, for each read RFID tag, the RFID tag information relative to the RFID tag information of at least one and typically two or more of the other read RFID tags of the set of RFID tags with which a tag is associated. In step 508, one or more sets of quantity estimation sets of rules are obtained to determine a quantity of items 130 supported by a product support system 110 associated with the set of RFID tags being evaluated. In step 510, the estimation set of rules are used and applied by the inventory estimation control circuit 102 to determine, based on the evaluation of the RFID tag information of the read RFID tags, a quantity of items 130 of one or more products that continue to be supported by a product support system 110.

Some embodiments use the one or more evaluation set of rules to determine whether a first RFID property of RFID tag information corresponding to a first RFID tag (e.g., RFID tag 108a) is within a threshold of a first RFID property of RFID tag information of a second RFID tag (e.g., RFID tag 108b). The inventory estimation control circuit can identify, for example when the first RFID property is not within the first threshold of the first RFID property, that at least one item 130 of the first product is positioned on the first product support system to interfere with the RFID signal from the first RFID tag. The estimation set of rules can be applied to determine a quantity of items 130 based on the determination that an item 130 of the first product is positioned to interfere with the RFID signal from the first RFID tag (e.g., 108a). In using the evaluation set of rules some embodiments determine whether one or more additional RFID properties of RFID tag information of the first RFID tag are each within a threshold of a corresponding one or more additional RFID properties of RFID tag information of a second RFID tag. The identification that at least one item of the first product is positioned on the first product support system to interfere with the RFID signal from the first RFID tag may be limited to only when at least both a first and a second RFID property associated with the first RFID tag are not within the first and second thresholds, respectively, of the first and second RFID properties associated with the second RFID tag.

The RFID tag information properties can include numerous different properties. Some embodiments, for example, consider RSSI information and use the evaluation set of rules to determine whether an RSSI of a first RFID tag is within a threshold of an RSSI of a second RFID tag. Based on this evaluation, the inventory estimation control circuit may identify that at least one item 130 of a product is positioned on the product support system 110 to interfere with an RFID signal from the first RFID tag (e.g., 108a). Further, one or more evaluation sets of rules can be used to determine the quantity of items 130 based at least on the determination that at least one item of the product is positioned to interfere with the RFID signal from the first RFID tag.

The inventory estimation control circuit can identify each of read RFID tags of a set of RFID tags. Sets of tags can be predefined as associated with a product support system. In some instances, for example, the RFID tags of a first set of RFID tags can be arranged at different heights relative to a depth of a product bin of a first product support system. The product bin can be configured to receive multiple items 130 of the first product with at least some of the multiple items being positioned under others of the multiple items within the bin such that as a quantity of the multiple items decreases over time more of the first set of RFID tags are exposed and the remaining multiple items do not interfere with the RFID signals from those exposed RFID tags of the first set. Some embodiments apply the estimation set of rules to identify, based on the evaluation of the RFID tag information of the read RFID tags, a sub-set of one or more of the RFID tags of the first set of RFID tags that have their RFID signal interfered with by one or more of the items of the first product. Based on known locations of each of the sub-set of RFID tags relative to the first product support system, a quantity of the items of the first product can be determined that continue to be supported by the first product support system. In identifying the sub-set of one or more of the RFID tags, come embodiments identify when a first RFID property of the RFID tag information associated with a first RFID tag is not within a first threshold of a first RFID property of the RFID tag information associated with a second RFID tag. Accordingly, some embodiments provide methods of determining a quantity of a product based on correlation between RFID tag information of multiple different RFID tags.

In some embodiments, the inventory estimation control circuit evaluates sequences of reads over time from one or more sets of RFID tags associated with a product support system. Based on these sequences, the inventory estimation control circuit can detect changes over time in estimating changes in quantities of items. Further, some embodiments track over time the changes in reads from the one or more sets of RFID tags and can determine estimated rates of sales and/or predict rates of sales based on the RFID tag reads. In some embodiments, the inventory estimation control circuit may additional obtain inventory information from the inventory system 122 and/or sales information from one or more point of sale systems 124 in cooperation with sequences of comparison evaluations of RFID tag information between multiple RFID tags in estimating and/or predicting sales floor demand and/or predicted sales. The inventory system may further receive such predicted rates of sales to identify when further items of a product should be ordered from a source (e.g., distribution center, supplier, etc.).

Additionally, in some embodiments, the inventory estimation control circuit can apply one or more sets of inventory control rules to identify when a product support system should be restocked with items of a product based on the determined quantity of the item remaining on the product support system, the predicted rate of sale, current levels of inventory and/or other such factors. The inventory estimation control circuit can communicate with the inventory system 122 to obtain information about current levels of inventory in a back storage area and/or other areas of the shopping facility, expected resupply of the product and/or other such information. The inventory estimation control circuit may further issue instructions to one or more workers to cause a restocking or picking of a product to a product support system based on a determined quantity of items of the product. For example, the picking instruction can be communicated to one or more user interface units 126 associated with a particular worker, printed on one or more task lists, displayed through a graphical user interface on a work station or other user interface unit, and/or other such methods.

Further, the quantity information determined by the inventory estimation control circuit 102 can be used to identify availability of one or more product support systems (e.g., shelf availability). Based on determined availability, the inventory estimation control circuit can be configured communicate with the inventory system 122 to notify the inventory system of the available space and allow the inventory system to select one or more items of one or more products to be placed onto the available space (e.g., based on size of shelf space and corresponding sizes of items). In some embodiments, the inventory estimation control circuit determines scheduling of one or more tasks to be performed based on the determined quantities and/or available space of the one or more product support systems. For example, the inventory estimation control circuit can schedule one or more pick task, one or more reorganization tasks, one or more move product tasks, and/or other such tasks. The inventory estimation control circuit may communicate with the inventory system to obtain inventory information (e.g., location of items of a product in a back storage area, quantities of the product in the back storage area, etc.) that is used in determine the scheduling of tasks and/or whether tasks should be performed. Further, inventory estimation control circuit may be configured to communicate instructions to perform the task, which identifies the task to be performed, the relevant product, the quantities, locations and the like, to one or more worker user interface units 126.

Some embodiments further use reads over time in detecting potential errors and other factors interfering with RFID tag reads. For example, the inventory estimation control circuit may detect a first RFID tag is being read at half the rate as several other RFID tags of the set and/or associated with a product support system. The inventory estimation control circuit can access RFID tag location information and applying one or more sets of at least one rule to identify that the first RFID tag is higher on the tower 112 than the several other tags (or placed at a location of a shelf that is expected to be exposed prior to one or more other RFID tags of the set). Based on this determination, the inventory estimation control circuit may identify that the read rate of the first RFID tag is not due to an item interfering with the first RFID tag (e.g., an item being at the top of the bin), but that there is some other environmental factor that is interfering with the reading of the first RFID tag or problem with the first RFID tag when the reduced read rate persists.

RFID tags have been used in the retail industry for a relatively long period of time. Their use, however, has presented some technological problems in this conventional industry practice and use. Present embodiments, however, improve the use of RFID tags and the computational evaluation of RFID tag information through the use of specific rules that render information into a specific format and are applied to estimate inventory quantities, instead of through human counting and human scanning, which both introduce significant margins of error. Further, the rules in part evaluate RFID tag properties relative to corresponding properties from different RFID tags within a set of RFID tags. Again, in some implementations that set of RFID tags are substantially similar providing substantially the same results when exposed to the same conditions, and/or are tested to obtain adjustments to compensate for variations in read RFID tag information between different RFID tags of a set. The present systems and processes specifically include multiple physical RFID tag readers distributed throughout areas of a retail facility and that are communicatively coupled with inventory estimation control circuit. The inventory estimation control circuit applies these uncharacteristic rules to transform the RFID tag information, from non-product RFID tags that are each associated with a product support system, into data that are used to compare RFID tag information of multiple different RFID tags of a set of RFID tags, and determine when RFID signals are being interfered with by one or more items. The present embodiments improve computer implemented inventory evaluation, rather than human process previously performed manually by workers, to apply specific rules to RFID tag information and specific rules to estimate quantities of products supported by a particular product support system within a retail facility. Further, the present embodiments provide a specific way, namely use of particular rules to evaluate different RFID tag information from a set of RFID tags to identify whether items are interfering with reads from those RFID tags, as well as the application of specific rules in estimating the quantity of products based on an identification RFID signals from specific RFID tags of a set that are not being interfered with by an item.

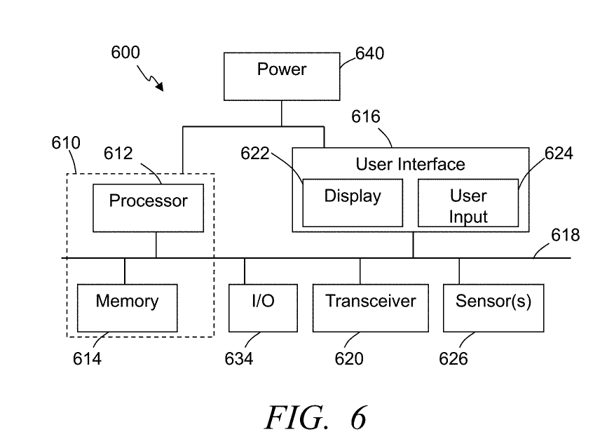

Further, the systems, circuits, circuitry, devices, units, processes, methods, techniques, functionality, services, servers, sources and the like described herein may be utilized, implemented and/or run on many different types of devices and/or systems. FIG. 6 illustrates an exemplary system 600 that may be used for implementing any of the systems, components, circuits, circuitry, units, functionality, apparatuses, processes, or devices of the retail product inventory tracking system 100, the inventory estimation control circuit 102, and/or other above or below mentioned systems or devices, or parts of such circuits, circuitry, functionality, systems, apparatuses, processes, or devices. For example, the system 600 may be used to implement some or all of the inventory estimation control circuit 102, the RFID tag readers 104, the central control system 118, inventory system 122, point-of-sale systems 124, user interface units 126, and/or other such components, circuitry, functionality and/or devices. However, the use of the system 600 or any portion thereof is certainly not required.

By way of example, the system 600 may comprise a control circuit or processor module 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like. For example, the system may implement the inventory estimation control circuit 102 with the control circuit 612 being an inventory estimation control circuit, the inventory system 122 with an inventory system control circuit, a point-of-sale system with the control circuit being a POS control circuit, the central control system 118 with a central control circuit, or other components.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network 106 (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) ports 634 that allow one or more devices to couple with the system 600. The I/O ports can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the inventory estimation control circuit 102, the central control system 118, the inventory system 122, a user interface unit 126, etc. The sensors can include substantially any relevant sensor, such as RFID tag readers, optical-based scanning sensors to sense and read optical patterns (e.g., bar codes), and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor-readable and/or computer-readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 106. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

In some embodiments, the product inventory tracking system 100 takes advantage of the effects that items 130 can have on RFID tag reads. In some implementations, RFID tags on positioned to be under items or where items are against or adjacent RFID tags. Items so positioned interfere with or completely block the RFID tag signal such that the RFID tags cannot be read or RFID tag parameters are affected while the item is in place. Then once an item or multiple items are removed (e.g., from a shelf), RFID tags can then be more accurately read. The RFID tag information can be evaluated relative to other RFID tags (e.g., one or more neighboring RFID tags) to identify those RFID tags that are interpreted to still be at least partially covered by one or more products. From that the inventory estimation control circuit can estimate or determine a quantity of items remain on or in the product support system 110. For example: the inventory estimation control circuit may access information specifying that there are 50 RFID tags in the milk section of a shopping facility. Based on received RFID tag information from one or more RFID tag readers, the inventory estimation control circuit can be configured to specify that just eight (8) of those 50 RFID tags are detected (e.g., at sufficient threshold levels). Using a mapping, the inventory estimation control circuit can identify that an RFID tag is positioned to correspond to a corresponding location to receive one milk product. Further, the inventory estimation control circuit can determine, based on the eight read RFID tags, that there are 42 milk items remaining on the one or more milk product support systems. Based on the unread remaining RFID tags, the inventory estimation control circuit interprets the unread RFID tags as being covered by a milk item, and can determine the on-hand quantity on the sales floor.

In some embodiments, one or more of the sets of RFID tags may represent fullness of a product support system (e.g., product in-stock “gauge” system). Further in some implementations, one or more of the sets of RFID tags comprises of an array of passive RFID tags placed under, on, in or adjacent a product support system. The multiple RFID tags of one or more sets of RFID tags may, in some embodiments, be positioned in an array pattern under radio frequency (RF) interfering items (e.g., fruits, milk, batteries, etc.). When one or more items are removed from their product support system, one or more of the RFID tags may be exposed, and thus available to be energized and read by one or more of an array of RFID tag readers (e.g., overhead RFID tag readers). When a the inventory estimation control circuit identifies that some or all of RFID tag information associated with a first RFID tag has one or more threshold relationships with one or more RFID tags of the set (e.g., one or more neighboring RFID tags), the inventory estimation control circuit can designate that the first RFID tag is exposed. Using the determined exposed RFID tags, determined partially exposed RFID tags, and/or the unexposed RFID tags, the inventory estimation control circuit can determine in stock quantities based on actual, average, mean or other such value of bin/shelf capacity. Using this information the inventory estimation control circuit 102, the central control system 118 and/or the inventory system 122 can communicate restocking instructions and/or signal to user interface units 126 of workers, to a display or report generating process of the inventory system or other such notification. Further, in some implementations, the notification or instruction may display a capacity of one or more bins, shelves or the like on an in-stock gas gauge type display/indicator where restocking is to be implemented. In some instances, one or more indicators may be associated with the product support system and be activated when the inventory of the number of items supported by the product support system drops below a predefined threshold. The system can be used with substantially any item that at least partially interferes with RFID signals from RFID tags, which may include for example, but not limited to, vegetables, can goods, dairy, car batteries, frozen items, water, carbonated drinks, juices, and other such RF interfering items.

In some embodiments, systems, apparatuses and corresponding methods performed by the systems, provide retail product inventory tracking systems configured to track product inventory on a sales floor of a retail shopping facility. The systems, in some embodiments, comprise: multiple sets of multiple radio frequency identification (RFID) tags strategically positioned relative to each of multiple different product support systems distributed throughout a retail shopping facility; multiple RFID tag readers distributed about the retail shopping facility; and an inventory estimation control circuit communicatively coupled with the multiple RFID tag readers, implementing code stored on memory and configured to: receive, from a first RFID tag reader of the multiple RFID tag readers, detected RFID tag information and an RFID tag identifier of each read RFID tag of a first set of non-product RFID tags cooperated with a first product support system of the multiple product support systems; obtain a first set of rules to evaluate RFID tag information associated with received RFID tag signals; use the first set of rules to evaluate, for each read RFID tag, the RFID tag information relative to the RFID tag information of two or more of the other read RFID tags of the first set of RFID tags; obtain a second set of rules to determine a quantity of items; use the second set of rules to determine, based on the evaluation of the RFID tag information of the read RFID tags, a quantity of items of a first product that continue to be supported by the first product support system.

Some embodiments provide methods of tracking retail product inventory on a sales floor of a retail shopping facility, comprising: by an inventory estimation control circuit communicatively coupled with the memory: receiving, from a first radio frequency identification (RFID) tag reader of multiple RFID tag readers distributed about a retail shopping facility, detected RFID tag information and an RFID tag identifier of each read RFID tag of a first set of non-product RFID tags cooperated with a first product support system of the multiple product support systems; obtaining a first set of rules to evaluate RFID tag information associated with received RFID tag signals; using the first set of rules to evaluate, for each read RFID tag, the RFID tag information relative to the RFID tag information of two or more of the other read RFID tags of the first set of RFID tags; obtaining a second set of rules to determine a quantity of items; using the second set of rules to determine, based on the evaluation of the RFID tag information of the read RFID tags, a quantity of items of a first product that continue to be supported by the first product support system.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail product inventory tracking system configured to track product inventory on a sales floor of a retail shopping facility, comprising:
multiple sets of multiple radio frequency identification (RFID) tags strategically positioned relative to each of multiple different product support systems distributed throughout a retail shopping facility;
multiple RFID tag readers distributed about the retail shopping facility; and
an inventory estimation control circuit communicatively coupled with the multiple RFID tag readers, implementing code stored on memory and configured to:
receive, from a first RFID tag reader of the multiple RFID tag readers, detected RFID tag information and an RFID tag identifier of each read RFID tag of a first set of non-product RFID tags cooperated with a first product support system of the multiple product support systems;
obtain a first set of rules to evaluate RFID tag information associated with received RFID tag signals;
use the first set of rules to evaluate, for each read RFID tag, the RFID tag information relative to the RFID tag information of two or more of the other read RFID tags of the first set of RFID tags;
obtain a second set of rules to determine a quantity of items; and
use the second set of rules to determine, based on the evaluation of the RFID tag information of the read RFID tags, a quantity of items of a first product that continue to be supported by the first product support system.

2. The system of claim 1, wherein the inventory estimation control circuit in using the first set of rules to evaluate the RFID tag information relative to RFID tag information of two or more of the other read RFID tags is configured to:
determine whether a first RFID property of RFID tag information of a first RFID tag is within a first threshold of the first RFID property of RFID tag information of a second RFID tag; and
identify, when the first RFID property of the first RFID tag is not within the first threshold of the first RFID property of the second RFID tag, that at least one item of the first product is positioned on the first product support system to interfere with a RFID signal from the first RFID tag; and
wherein the inventory estimation control circuit in using the second set of rules to determine the quantity of items determines the quantity of items based on the determination that the at least one item of the first product is positioned to interfere with the RFID signal from the first RFID tag.

3. The system of claim 1, wherein the inventory estimation control circuit in using the first set of rules to evaluate the RFID tag information relative to RFID tag information of two or more of the other read RFID tags is configured to:
determine whether a second RFID property of the RFID tag information of the first RFID tag is within a second threshold of the second RFID property of the RFID tag information of a second RFID tag; and
identify, only when at least both the first and second RFID properties associated with the first RFID tag are not within the first and second thresholds, respectively, of the first and second RFID properties associated with the second RFID tag, that at least one item of the first product is positioned on the first product support system to interfere with the RFID signal from the first RFID tag.

4. The system of claim 1, wherein the RFID tag information comprises Received Signal Strength Indicator (RSSI), and wherein the inventory estimation control circuit in using the first set of rules to evaluate the RFID tag information relative to RFID tag information of two or more of the other read RFID tags is configured to:
determine whether an RSSI of a first RFID tag is within a threshold of an RSSI of a second RFID tag; and
identifying that at least one item of the first product is positioned on the first product support system to interfere with a RFID signal from the first RFID tag; and
wherein the inventory estimation control circuit in using the second set of rules to determine the quantity of items determines the quantity of items based on the determination that the at least one item of the first product is positioned to interfere with the RFID signal from the first RFID tag.

5. The system of claim 1, wherein the RFID tags of the first set of RFID tags are arranged at different heights relative to a depth of a product bin of the first product support system, wherein the product bin is configured to receive multiple items of the first product with at least some of the multiple items being positioned under others of the multiple items within the bin.

6. The system of claim 1, wherein the inventory estimation control circuit, in using the second set of rules to determine the quantity of items, is configured to:
identify, based on the evaluation of the RFID tag information of the read RFID tags, a sub-set of one or more of the RFID tags of the first set of RFID tags that have their RFID signal interfered with by one or more of the items of the first product; and
determine, based on known locations of each of the sub-set of RFID tags relative to the first product support system, a quantity of the items of the first product that continue to be supported by the first product support system.

7. The system of claim 6, wherein the inventory estimation control circuit, in identifying the sub-set of one or more of the RFID tags, is configured to identify when a first RFID property of the RFID tag information associated with a first RFID tag is not within a first threshold of a first RFID property of the RFID tag information associated with a second RFID tag.

8. A method of tracking retail product inventory on a sales floor of a retail shopping facility, comprising:
by an inventory estimation control circuit communicatively coupled with the memory:
receiving, from a first radio frequency identification (RFID) tag reader of multiple RFID tag readers distributed about a retail shopping facility, detected RFID tag information and an RFID tag identifier of each read RFID tag of a first set of non-product RFID tags cooperated with a first product support system of the multiple product support systems;
obtaining a first set of rules to evaluate RFID tag information associated with received RFID tag signals;
evaluating, for each read RFID tag and based on the application of the first set of rules, the RFID tag information relative to the RFID tag information of two or more of the other read RFID tags of the first set of RFID tags;
obtaining a second set of rules to determine a quantity of items; and
determining, in accordance with the application of the second set of rules and based on the evaluation of the RFID tag information of the read RFID tags, a quantity of items of a first product that continue to be supported by the first product support system.

9. The method of claim 8, wherein the evaluating, based on the first set of rules, the RFID tag information comprises:
determining whether a first RFID property of RFID tag information of a first RFID tag is within a first threshold of the first RFID property of RFID tag information of a second RFID tag; and
identifying, when the first RFID property of the first RFID tag is not within the first threshold of the first RFID property of the first RFID tag, that at least one item of the first product is positioned on the first product support system to interfere with a RFID signal from the first RFID tag; and
wherein the determining, based on application of the second set of rules, the quantity of items comprises determining the quantity of items based on the determination that the at least one item of the first product is positioned to interfere with the RFID signal from the first RFID tag.

10. The method of claim 8, wherein the evaluating, using the first set of rules, the RFID tag information comprises:
determining whether a second RFID property of the RFID tag information of the first RFID tag is within a second threshold of the second RFID property of the RFID tag information of a second RFID tag; and
identifying, only when at least both the first and second RFID properties associated with the first RFID tag are not within the first and second thresholds, respectively, of the first and second RFID properties associated with the second RFID tag, that at least one item of the first product is positioned on the first product support system to interfere with the RFID signal from the first RFID tag.

11. The method of claim 8, wherein the RFID tag information comprises Received Signal Strength Indicator (RSSI), and wherein the evaluating, using the first set of rules, the RFID tag information comprises:
determining whether an RSSI of a first RFID tag is within a threshold of an RSSI of a second RFID tag; and
identifying that at least one item of the first product is positioned on the first product support system to interfere with a RFID signal from the first RFID tag; and
wherein the determining, using the second set of rules, the quantity of items comprises determining the quantity of items based on the determination that the at least one item of the first product is positioned to interfere with the RFID signal from the first RFID tag.

12. The method of claim 8, further comprising:
identifying each of the read RFID tags of the first set of RFID tags wherein the RFID tags of the first set of RFID tags are arranged at different heights relative to a depth of a product bin of the first product support system, and wherein the product bin is configured to receive multiple items of the first product with at least some of the multiple items being positioned under others of the multiple items within the bin.

13. The method of claim 8, wherein the determining, using the second set of rules, the quantity of items comprises:
identifying, based on the evaluation of the RFID tag information of the read RFID tags, a sub-set of one or more of the RFID tags of the first set of RFID tags that have their RFID signal interfered with by one or more of the items of the first product; and
determining, based on known locations of each of the sub-set of RFID tags relative to the first product support system, a quantity of the items of the first product that continue to be supported by the first product support system.

14. The method of claim 13, wherein the identifying the sub-set of one or more of the RFID tags comprises identifying when a first RFID property of the RFID tag information associated with a first RFID tag is not within a first threshold of a first RFID property of the RFID tag information associated with a second RFID tag.
